(19) United States
(12) Patent Application Publication
(10) Pub. No.: US 2026/0136148 A1
(43) Pub. Date: May 14, 2026

(54) CONVERSION OF SCENE BASED AUDIO REPRESENTATIONS TO OBJECT BASED AUDIO REPRESENTATIONS

(71) Applicant: DOLBY LABORATORIES LICENSING CORPORATION

(72) Inventors: David S. MCGRATH, Rose Bay (AU); Michael HOFFMANN, Beaverton, OR (US)

(73) Assignee: DOLBY LABORATORIES LICENSING CORPORATION, (US)

(21) Appl. No.: 19/119,681

(22) PCT Filed: Sep. 25, 2023
(86) PCT No.: PCT/US2023/075043

§ 371 Date: Apr. 9, 2025

Related U.S. Application Data
(60) Provisional application No. 63/379,081, filed on Oct. 11, 2022.
(60) Provisional application No. 63/479,236, filed on Jan. 10, 2023.
(60) Provisional application No. 63/519,787, filed on Aug. 15, 2023.

(51) Int. Cl. H04S 7/00; G06T 7/70; H04S 3/00

(52) U.S. Cl. CPC H04S 7/302; G06T 7/70; H04S 3/008; H04S 7/307; G06T 2207/10016; H04S 2400/01; H04S 2400/11; H04S 2400/13; H04S 2420/07; H04S 2420/11

(57) ABSTRACT

A mixing matrix, suitable for converting a scene-based audio (SBA) input signal to an object-based audio (OBA) signal, is constructed so that the resulting OBA signal is composed of object signals with amplitudes that are biased according to amplitude preference coefficients. The amplitude preference coefficients are chosen to place dominant spatial audio objects in a fewer number of output object channels, to provide a more discrete OBA rendering of the SBA input signal.

### CROSS-REFERENCE TO RELATED APPLICATIONS

This application claims the benefit of priority from U.S. Provisional Application No. 63/379,081 filed on 11 Oct. 2022, U.S. Provisional Application No. 63/479,236 filed on 10 Jan. 2023, and U.S. Provisional Application No. 63/519,787 filed on 15 Aug. 2023, each of which is incorporated by reference herein in its entirety.

### TECHNICAL FIELD

The present disclosure relates to the use of multi-channel audio formats to represent acoustic scenes, and in particular, to the conversion between different audio formats that represent the same acoustic scene.

### BACKGROUND

A set of audio signals may be processed and then transmitted through transducers (such as loudspeakers) with the aim being to recreate a desired listening experience to one or more listeners. The set of audio signals may be referred to herein as a “multi-channel audio signal.” A listening experience may be referred to herein as an “audio scene,” and in particular, the term “target audio scene” refers to the desired listening experience (i.e., the listening experience that the multi-channel audio signal is intended to recreate).

A multi-channel audio signal will typically be associated with additional information that defines how the target audio scene is related to the multi-channel audio signal. This additional information will include the name of the “format” of the multi-channel audio signal. Typical formats include the commonly known channel-based formats: stereo, 5.1, 7.1, etc., as known in the art (referred to collectively as channel-based audio (CBA)). In the case of these CBA formats, the method by which the target audio scene is defined is in terms of the transmission of each channel of the multi-channel audio signal through a corresponding loudspeaker, where placement of the loudspeakers around a listener is defined by the format. Typical formats also include object-based audio (OBA) formats, wherein the target audio scene is defined in terms of the transmission of each channel of the multi-channel audio signal to the listener, wherein the perceived DOA of each of the channels is defined by additional metadata, as is known in the art. An example of an OBA format is Dolby Atmos® developed by Dolby Laboratories of San Francisco. California, USA.

An audio channel, within the multi-channel signal, that is associated with a DOA that changes over time, may be referred to as a dynamic object, and an audio channel, within the multi-channel signal, that is associated with a DOA that does not change over time, may be referred to as a static object. An audio scene that is defined by a CBA format may be represented by an OBA format, by defining a static object for each of the channels of the original CBA format.

Typical formats also include scene-based audio (SBA) formats, wherein the multi-channel signal defines the target audio scene in terms of the target acoustic wave-field that should be recreated in the near vicinity of the listening position. Scene-based formats do not prescribe the method by which the target acoustic wave-field should be produced. Furthermore, given the complexity of acoustic wave-fields, a multi-channel audio signal may only attempt to define a subset of the information related to the acoustic wave-field. A common family of SBA formats is Ambisonics. The first order Ambisonics (FOA) format defines a target audio scene by providing a multi-channel audio file consisting of 4 channels, wherein each of the 4 channels defines the signal that is expected to be received by a respective ideal microphone positioned at a central point within the target acoustic wave-field, and wherein each of the microphones is responsive to incident sounds according to a specific directivity pattern.

According to the convention adopted in the field of Ambisonics production the incident DOA of sounds is defined according to a 3-dimensional coordinate system where the X-axis points forward, the Y-axis points to the left, and the Z-axis points up. In FOA format, the 4 microphone directivity patterns are chosen to be an omni-directional pattern plus 3 dipole patterns where the 3 dipole patterns are aligned with the X, Y and Z axes respectively. By way of example, an ideal dipole microphone aligned with the X-axis will capture the incident sound with a gain equal to x when exposed to an incident sound wave from a direction defined by the unit-vector (x,y,z). An ideal omnidirectional microphone pattern can be considered to have a receiving gain of 1, independent of the incident direction of the sound wave.

### SUMMARY

A mixing matrix, suitable for converting a scene-based audio input signal to an object-based audio output signal, is constructed so that the resulting object-based audio signal is composed of object signals with amplitudes that are biased according to amplitude preference coefficients. The amplitude preference coefficients are chosen to place dominant spatial audio objects in a fewer number of output object channels, to provide a more discrete object-based rendering of the scene-based audio input signal.

In some embodiments, a method comprises: determining an object mapping matrix that defines linear mixing characteristics that map audio objects from an object-based format to a scene-based format; determining a cost-factor for each audio object of the object-based format; determining a scene mapping matrix as a generalized inverse of the object mapping matrix, wherein the scene mapping matrix is determined so as to minimize a sum of weighted energies of the audio objects, wherein the weighted energy of each particular audio object is scaled according to its respective determined cost factor; and generating an object-based audio signal including audio object signals as a mixture of audio signals from a scene-based input signal according to the scene mapping matrix.

In some embodiments, the scene-based input signal is an M-channel multi-channel audio signal, each cost factor is a function of an amplitude preference for its corresponding audio object, and the amplitude preference of each audio object is determined from a weighted sum of the elements of the matrix, C, where C is an M×M covariance of the M-channel scene-based input signal, and where the weights are determined so as to form amplitude preference values that approximate an object-based panning function.

In some embodiments, each of the audio objects is associated with an object location, the scene-based input signal is associated with a dominant direction, and each of the cost factors is defined to be lower for audio objects with associated object locations that are closer to the dominant direction.

In some embodiments, the audio object is a dynamic audio object having a location that is determined through video scene analysis.

In some embodiments, the method further comprises estimating, from the scene-based input signal, the dominant direction and a directional bias coefficient that indicates a fraction of the scene-based input signal energy that emanates from the dominant direction.

In some embodiments, each cost factor is a function of an amplitude preference for its corresponding audio object, and the amplitude preference is a function of an incident direction of the audio object, the dominant direction and the direction bias coefficient.

In some embodiments, the function provides larger values of the amplitude preference when the incident direction lies closer to the dominant direction

In some embodiments, the scene-based input signal is an M-channel multi-channel audio signal and the dominant direction, V_{dom}, is unit vector that maximizes the value of

$${V}_{dom}^{*} x {C}^{- 1} {V}_{dom} ,$$

where C is an M×M covariance of the M-channel scene-based input signal, and where the “*” operator indicates a transpose.

In some embodiments, the dominant direction is formed from elements of the covariance matrix C.

In some embodiments, the scene-based input signal is defined according to a first order Ambisonics panning function.

In some embodiments, the scene-based input signal is split into two or more subband scene-based signals according to a frequency selective filtering process, where for each subband the respective scene-based subband signal is converted to a separate object-based subband signal.

### BRIEF DESCRIPTION OF THE DRAWINGS

Embodiments disclosed herein will now be described, by way of example only, with reference to the accompanying drawings in which:

FIG. 1A illustrates the use of a converter for converting an SBA representation to an OBA representation, according to one or more embodiments.

FIG. 1B is a diagram of an arrangement of sound emitting objects around a central reference point, according to one or more embodiments.

FIG. 2 is a diagram of a scene mapping matrix generator for determining a scene mapping matrix, according to one or more embodiments.

FIG. 3 is a diagram of showing the determination of object audio signals, according to one or more embodiments.

FIG. 4 is a diagram of showing the determination of object audio signals, including determining object locations, according to one or more embodiments,

FIG. 5 is a diagram of showing the determination of object audio signals, including determining object locations for a set of sub-bands, according to one or more embodiments.

FIG. 6 is a block diagram of a system for detecting dominant spatial objects to generate amplitude preference coefficients for a SBA mapping matrix that places the detected dominant spatial audio objects in a fewer number of output object channels in an OBA format, thus providing a more discrete OBA rendering of the SBA input signal, according one or more embodiments.

FIG. 7 is a flow diagram of an example process for converting SBA to OBA representation(s), according to one or more embodiments.

FIG. 8 is a block diagram of an example hardware architecture suitable for implementing the systems and methods described in reference to FIGS. 1-7.

### DETAILED DESCRIPTION

Described herein are techniques related to conversion of audio signals from one format to another. In the following description, for purposes of explanation, numerous examples and specific details are set forth in order to provide a thorough understanding of the present disclosure. It will be evident, however, to one skilled in the art that the present disclosure as defined by the claims may include some or all of the features in these examples alone or in combination with other features described below and may further include modifications and equivalents of the features and concepts described herein.

In the following description, various methods, processes, and procedures are detailed. Although particular steps may be described in a certain order, such order is mainly for convenience and clarity. A particular step may be repeated more than once, may occur before or after other steps (even if those steps are otherwise described in another order), and may occur in parallel with other steps. A second step is required to follow a first step only when the first step must be completed before the second step is begun. Such a situation will be specifically pointed out when not clear from the context.

In this document, the terms “and”, “or” and “and/or” are used. Such terms are to be read as having an inclusive meaning. For example, “A and B” may mean at least the following: “both A and B”, “at least both A and B”. As another example, “A or B” may mean at least the following: “at least A”, “at least B”, “both A and B”, “at least both A and B”. As another example, “A and/or B” may mean at least the following: “A and B”, “A or B”. When an exclusive-or is intended, such will be specifically noted (e.g., “either A or B”, “at most one of A and B”).

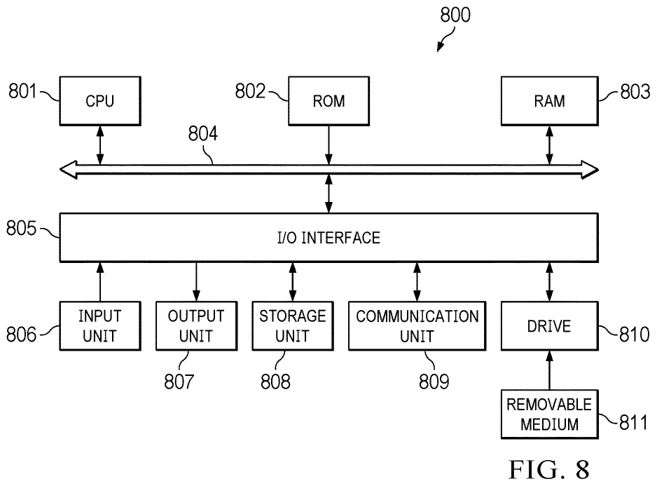

This document describes various processing functions that are associated with structures such as blocks, elements, components, circuits, etc. In general, these structures may be implemented by a processor that is controlled by one or more computer programs, as described, for example, in reference to FIG. 8.

### Overview

The disclosed embodiments are directed to methods, apparatus, and systems for processing SBA signals into OBA signals that can be consumed by any playback and/or intermediate processing device that is capable of rendering OBA signals (e.g., Dolby Atmos®). Such processing allows various playback and/or intermediate processing systems the flexibility of utilizing SBA signals in an OBA listening environment.

SBA is a format for three-dimensional (3D) audio that allows for accurate capturing, efficient delivery, and rendering of 3D audio sound fields on any device, such as headphones, arbitrary loudspeaker configurations, soundbars, etc. An SBA signal comprises a number of channels that describe an audio scene from a listening position. An example SBA format is higher order Ambisonics (HOA). Unlike CBA formats, the HOA transmission channels contain a speaker-independent representation of a sound field, which can be decoded to a listener's speaker setup. SBA allows the audio content producer to represent an audio scene in terms of source directions rather than loudspeaker positions and provides the listener flexibility as to the speaker layout and number of speakers used for playback.

OBA is a format that treats each sound source as an independent object with its own metadata, such as location, volume, and direction. OBA allows the audio to be rendered dynamically according to the listener's speaker layout, the listener's position, and the acoustic properties of the listening environment.

### Ambisonics Background Overview

Methods exist for mapping OBA to SBA. Such mappings can be generally explained by a panning function P₁(x,y,z) that maps a DOA of an Ambisonics audio scene (in the form of the unit-vector (x,y,z)) to a column vector of N gain values that respectively correspond to gains for rendering N objects. In an example of N=4, that would correspond to FOA, and the panning of such a FOA format to N=4 objects would be conceptually based on Equation 1 as shown below:

$${P}_{1} ( x , y , z ) = [ \begin{matrix}1 \\ y \\ z \\ x\end{matrix} ] \qquad ( 1 )$$

Multiple conventions exist for defining the gain-scale and channel ordering of signals in an Ambisonics format. The methods, apparatus and systems described herein may be applied to Ambisonics signals that adhere to alternative scale and channel-order conventions, without loss of generality. While CBA formats with 7 or more channels are becoming more wide-spread, a scene-based 4-channel format such as FOA will attempt to define a target audio scene with a relatively small number (e.g., 4) of audio channels.

An audio scene can be represented in terms of second or third order Ambisonics formats (referred to as HOA), consisting of 9 or 16 channels respectively. The associated panning functions P₂(x,y,z) and P₃(x,y,z) for converting such second order or third order HOA to objects can be implemented in accordance to principles illustrated in the panning functions of Equation 2 and Equation 3, respectively.

$${P}_{2} ( x , y , z ) = [ \begin{matrix}1 \\ y \\ z \\ x \\ \sqrt{3} xy \\ \sqrt{3} yz \\ \frac{1}{2} ( 2 {z}^{2} - {x}^{2} - {y}^{2} ) \\ \sqrt{3} xz \\ \frac{\sqrt{3}}{2} ( {x}^{2} - {y}^{2} )\end{matrix} ] \qquad ( 2 )$$

$${P}_{2} ( x , y , z ) = [ \begin{matrix}1 \\ y \\ z \\ x \\ \sqrt{3} xy \\ \sqrt{3} yz \\ \frac{1}{2} ( 2 {z}^{2} - {x}^{2} - {y}^{2} ) \\ \sqrt{3} xz \\ \frac{\sqrt{3}}{2} ( {x}^{2} - {y}^{2} ) \\ \frac{\sqrt{5}}{\sqrt{8}} ( 3 {x}^{2} y - {y}^{3} ) \\ \sqrt{15} xyz \\ \frac{\sqrt{3}}{\sqrt{8}} ( 4 {yz}^{2} - {yx}^{2} - {y}^{3} ) \\ \frac{1}{2} ( 2 {z}^{2} - 3 {x}^{2} z - 3 {y}^{2} z ) \\ \frac{\sqrt{3}}{\sqrt{8}} ( 4 {xz}^{2} - {xy}^{2} - {x}^{3} ) \\ \frac{\sqrt{15}}{2} ( {x}^{2} z - {y}^{2} z ) \\ \frac{\sqrt{5}}{\sqrt{8}} ( {x}^{3} - 3 {xy}^{2} )\end{matrix} ] \qquad ( 3 )$$

SBA, such as HOA are useful because they allow complex audio scenes to be represented in a multi-channel signal that allows for easy manipulation and analysis using readily available audio processing tools. However, these methods are limited to converting OBA to SBA. It is desirable, but more difficult, to convert a scene-based format into a channel-based or object-based format. The disclosed embodiments perform such a mapping to provide SBA to OBA conversion.

### Object-Based Audio Overview

An object-based audio signal comprises of audio signals that are intended to be transmitted from a set of audio emitting devices, where each audio emitting device is located at a specified position relative to a central listening position. The OBA format can be formed from N objects, where the value of N can be greater than equal to 1. Such objects can be represented, for example by object n (n=1, 2, . . . , N) that has associated with it an audio signal Oₙ(t) and an object incident direction vector Vₙ=[xₙ, yₙ, zₙ]^{T}, where the object incident direction vector defines the spatial position of an audio object in 3D audio scene.

Preferably, without loss of generality, parameter Vₙ is a unit-vector, so that:

$${‖ {V}_{n} ‖}_{2} = \sqrt{{x}_{n}^{2} + {y}_{n}^{2} + {z}_{n}^{2}} = 1.$$

The audio signal O(t) can be represented by a [N×1] column-vector formed by the N object-audio signals, {Oₙ(t): n=1 N}. In an alternative preferred embodiment, the object incident direction may also vary as a function of time: Vₙ(t).

### Conversion of Scene-Based Audio to Object-Based Audio

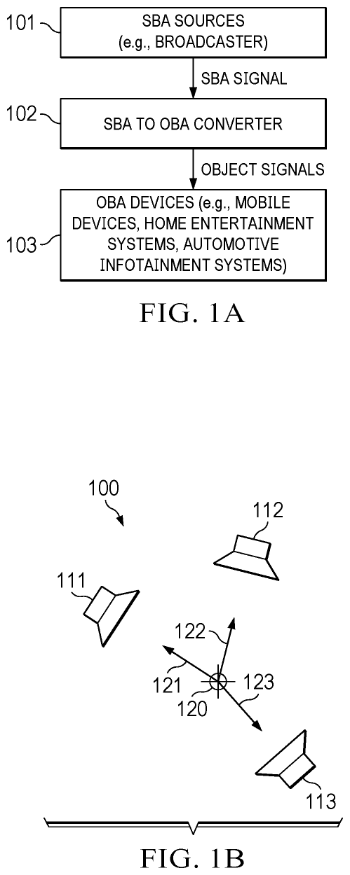

FIG. 1A illustrates the use of a converter for converting an SBA representation to an OBA representation, according to one or more embodiments. SBA signal sources 101 generate SBA signals that are received by SBA-to-OBA converter 102 in the form of a bitstream, which may include metadata. The SBA signals are converted to OBA signals by SBA to OBA converter 102. The OBA signals can be utilized by a variety of downstream receiving devices 103, including but not limited to: mobile devices (e.g., smartphones, tablet computers, home entertainment systems, automotive infotainment systems, etc.). The OBA signals can be rendered for playback in OBA format, CBA format (e.g., 5.1, 7.1 surround), binaural (e.g., for headphones, earbuds, etc.). Alternatively, the OBA signals can be further processed, transmitted to other devices, stored, or

The disclosed embodiments can be implemented in an audio encoder, decoder, intermediate processing device or in a general processing environment. In an encoder or audio content creator environment, a preprocessing module can implement the disclosed embodiments. For example, the disclosed embodiments can be utilized by an encoder or content creator to incorporate SBA (e.g., FOA, HOA) into an OBA production (e.g., a Dolby Atmos® production), by converting the SBA channels to a set of objects using the disclosed embodiments.

Alternatively, or in addition, the disclosed embodiments can be implemented after a decoding process in a listening environment where an SBA stream was produced at the output of a decoder, but audio objects are needed for the purpose of rendering the audio in the listening environment. For example, if SBA audio is to be rendered to speakers in an OBA format, the disclosed embodiments can be utilized to convert the channels of the SBA signal into OBA signals that are rendered to speaker signals for playback by loudspeakers or binaurally rendered for playback on headphones/ear buds.

The processing blocks implementing the disclosed embodiments can be implemented in audio and/or audio video environments, such as mobile devices, wearable devices, home entertainment systems, smartphones, tablet computers, virtual reality (VR), augmented reality (AR) and mixed reality (MR) headsets/goggles/glasses, gaming consoles, automotive infotainment systems, and any other device capable of processing and/or rendering OBA.

### Example SBA Workflow

An example SBA workflow generally includes three stages: production, transport, and reproduction. In the production stage the mixing engineer creates 3D audio content in HOA by mixing various audio sources (e.g., feeds from spot microphones, stems, Ambisonics microphones, etc.) using appropriate tools to perform the HOA transform. In the transport stage the set of HOA signals are compressed and sent to the end user in an audio bitstream (e.g., an MPEG-H audio bitstream) or any other suitable bitstream format or transport mechanism. In the reproduction stage the audio decoder (e.g., MPEG-H audio decoder) at the user's end receives and decodes the audio bitstream to retrieve the HOA signals. The HOA signals can then be further manipulated and customized (e.g., rotation of the sound field in VR applications or audio “zoom” in a desired direction). Finally, the HOA renderer creates the appropriate feeds for the reproduction device. In some embodiments, dialogues, commentaries, or audio descriptions can be sent as separate audio objects, as required.

In the reproduction stage, a content producer can use the disclosed embodiments to convert SBA signals into OBA signals to perform specific tasks that cannot be performed using CBA or SBA. For example, in a live sport production scenario, a mixing engineer can deliver two commentaries in two different languages (e.g., English, Spanish) as audio objects (separate from the mix), allowing an English-speaking end user to select the English commentary and a Spanish-speaking end user to select the Spanish commentary using their respective playback devices.

In some embodiments, the SBA signal can be analyzed and used to determine if any the audio object should be moved so that the object is in better location to ‘align’ with a dominant SBA channel. In some embodiments, an external location source can be used, such as video analysis.

### Derivation of SBA to OBA Mapping Matrix

To convert SBA to OBA, the disclosed embodiments provide a generalized inverse of an OBA to SBA mapping. The derivation of the SBA to OBA mapping is now discussed in reference to FIG. 1B.

FIG. 1B shows an arrangement 100 of sound emitting devices 111, 112, 113, arranged around a central reference location 120, according to one or more embodiments. The sound emitted by each emitting device 111, 112, 113, is incident at the central reference location 120 from an incident DOA 121, 122, 123 respectively. A 3-channel (N=3) OBA signal is rendered according to the arrangement 100 in FIG. 1B. Audio signal O₁(t) may be transmitted from emitter 111, producing a soundwave that is incident at the central reference location 120, from the direction 121 specified by the unit vector V₁. Likewise audio signals O₂(t) and O₃(t) may be transmitted from emitters 112 and 113, being incident at the central reference location 120, from the directions 121 and 122 specified by the unit vectors V₂ and V₃ respectively.

The audio scene in the vicinity of the central reference location 120 is defined by the object audio signals O₁(t), O₂(t) and O₃(t) along with the associated incident directions V₁, V₂ and V₃. The audio scene may also be represented by an SBA signal comprising of M audio channels (S₁(t), S₂(t), . . . S_{M}(t)), where each audio channel is formed from the sum of the incident audio signals at the central reference location 120, and where each incident audio signal is scaled according to a panning gain function associated with SBA channel. The signal vector S(t) represented the [M×1] column-vector formed by the M SBA signals, {Sₘ(t): m=1 . . . M}.

In an embodiment, the panning gain function maps each incident direction of arrival to a [M×1] column-vector of panning-gains. These principles are exemplarily illustrated in conjunction with Equation 4 as follows:

$$P ( x , y , z ) = [ \begin{matrix}{g}_{1} ( x , y , z ) \\ {g}_{2} ( x , y , z ) \\ ⋮ \\ {g}_{M} ( x , y , z )\end{matrix} ] . \qquad ( 4 )$$

Alternatively, for the sake of simplicity, the panning gain function may be defined in terms of the [3×1] unit vector [x,y,z]^{T}=V. The principles that are exemplarily implemented in Equation 4 may be written in a more compact form as in Equation 5:

$$P ( V ) = [ \begin{matrix}{g}_{1} ( V ) \\ {g}_{2} ( V ) \\ ⋮ \\ {g}_{M} ( V )\end{matrix} ] . \qquad ( 5 )$$

In an embodiment, an object-mapping matrix E is determined according to the principles described in connection with Equation 8, so that its generalized inverse can be determined according to the principles described in connection with Equations 10 and 11. An object-based format consisting of N object signals. O₁(t), O₂(t), . . . O_{N}(t), with associated direction of arrival vectors, V₁, V₂, . . . V_{N}, may be converted to an M-channel scene-based format: S₁(t), S₂ (t), . . . S_{M}(t) (defined by the scene-based panning function in Equation 5), according to the principles that are exemplarily implemented in Equation 6:

$$[ \begin{matrix}{S}_{1} ( t ) \\ {S}_{2} ( t ) \\ ⋮ \\ {S}_{M} ( t )\end{matrix} ] = [ \begin{matrix}{g}_{1} ( {V}_{1} ) & {g}_{1} ( {V}_{2} ) & … & {g}_{1} ( {V}_{N} ) \\ {g}_{2} ( {V}_{1} ) & {g}_{2} ( {V}_{2} ) & … & {g}_{2} ( {V}_{N} ) \\ ⋮ & ⋮ & ⋱ & ⋮ \\ {g}_{M} ( {V}_{1} ) & {g}_{M} ( {V}_{2} ) & … & {g}_{M} ( {V}_{N} )\end{matrix} ] \times [ \begin{matrix}{O}_{1} ( t ) \\ {O}_{2} ( t ) \\ ⋮ \\ {O}_{N} ( t )\end{matrix} ] \qquad ( 6 )$$

The principles that are exemplarily implemented in Equation 6 may be re-written as shown in Equation 7:

$$S ( t ) = E \times O ( t ) . \qquad ( t )$$

where S(t) and O(t) are the scene-based and object-based signal vectors respectively, and the [M×N] object-mapping matrix E is given by:

$$E = [ \begin{matrix}{g}_{1} ( {V}_{1} ) & {g}_{1} ( {V}_{2} ) & … & {g}_{1} ( {V}_{N} ) \\ {g}_{2} ( {V}_{1} ) & {g}_{2} ( {V}_{2} ) & … & {g}_{2} ( {V}_{N} ) \\ ⋮ & ⋮ & ⋱ & ⋮ \\ {g}_{M} ( {V}_{1} ) & {g}_{M} ( {V}_{2} ) & … & {g}_{M} ( {V}_{N} )\end{matrix} ] . \qquad ( 8 )$$

The object-based signal vector can be determined by multiplying the scene-mapping matrix D by the scene-based signal vector. These principles may be exemplarily illustrated with Equation 9 as follows:

$$O ( t ) = D \times S ( t ) , \qquad ( 9 )$$

where the [N×M] scene-mapping matrix D is chosen to satisfy Equation 10:

$$E \times D = {I}_{M} , \qquad ( 10 )$$

and where I_{M} is the [M×M] identity matrix.

In an embodiment, because the number of objects, N, is greater than the number of scene-based channels, M (so that N>M) there will generally be more than one scene-mapping matrix D that satisfies Equation 10, and any such scene-mapping matrix, D, that satisfies Equation 10 is known as a generalized inverse of the matrix E.

The expanded form of the scene-mapping matrix, D, is shown in accordance with the principles of Equation 11:

$$D = [ \begin{matrix}{d}_{1 , 1} & {d}_{1 , 2} & … & {d}_{1 , N} \\ {d}_{2 , 1} & {d}_{2 , 2} & … & {d}_{2 , N} \\ ⋮ & ⋮ & ⋱ & ⋮ \\ {d}_{M , 1} & {d}_{M , 2} & … & {d}_{M , N}\end{matrix} ] \qquad ( 11 )$$

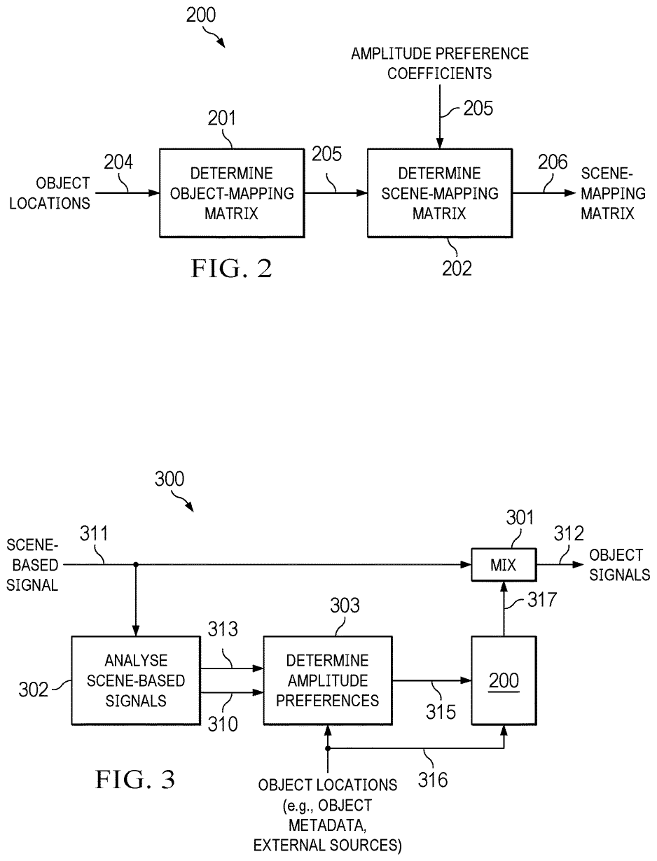

The function of the D matrix (shown as 205 in FIG. 2 described below) is to define the way the OBA signals are generated from the SBA signals (according to the principles discussed in connection with Equation 9) and in an embodiment, it is desirable to choose D so as to increase or reduce the power in some OBA signals, while D still satisfies Equation 10. In a further embodiment, the permitted amplitude of each object channel (m=1, 2, . . . , M) may be defined by the parameter aₘ.

Because there is more than one scene-mapping matrix D that satisfies Equation 10, a scene-mapping matrix, D that satisfies Equation 10 may be associated with cost-function, β(D), as shown in Equation 12:

$$β ( D ) = {\sum }_{m = 1}^{M} {\sum }_{n = 1}^{N} {( \frac{1}{{a}_{m}} )}^{2} {\vert {d}_{m , n} \vert}^{2} \qquad ( 12 )$$

where the generalized inverse matrix, D, is chosen to minimize the cost function. β(D). A lower amplitude-preference, aₘ, will be associated with a higher contribution of the power of row m of the matrix D to the cost-function.

According to an alternative terminology, each object may be associated with a cost-factor:

$${cost}_{m} = {( \frac{1}{{a}_{m}} )}^{2} , \qquad ( 13 )$$

where aₘ is the permitted amplitude of each object channel m, such that an object channel with a lower amplitude-preference, aₘ (a preference for which object will be allocated the most energy) is associated with a larger cost-factor.

To minimize the cost function according to the principles that are exemplarily implemented in Equation 15, an amplitude preference matrix, A is defined according to the principles that are exemplarily implemented in Equation 14:

$$A = [ \begin{matrix}{a}_{1} & 0 & … & 0 \\ 0 & {a}_{2} & … & 0 \\ ⋮ & ⋮ & ⋱ & ⋮ \\ 0 & 0 & … & {a}_{M}\end{matrix} ] . \qquad ( 14 )$$

The scene-mapping matrix D can be determined such that it satisfies Equation 10 while minimizing the cost function. β(D), according to Equation 15, wherein the scene-mapping matrix, D, is defined in terms of the object-mapping matrix, E, and the amplitude preference matrix, A.

$$D = A \times A \times {E}^{*} \times {( E \times A \times A \times {E}^{*} )}^{- 1} , \qquad ( 15 )$$

where the ( )⁻¹ operator indicates the matrix-inverse, and the ( )* operator indicates the matrix transpose (or, if the object-mapping matrix E includes complex coefficients, the Hermitian transpose, as is known in the art).

The principles of Equation 15 may alternately be expressed as per Equation 16:

$$D = A \times {( E \times A )}^{+} , \qquad ( 16 )$$

where the ( )⁺ operator indicates the pseudo-inverse, as is known in the art.

### System for Generating Scene-Mapping Matrix

As previously discussed, SBA signals can be mapped to OBA signals by first computing the object-mapping matrix E that maps OBA signals to SBA signals according to the principles discussed in connection with Equation 8, and then determining the generalized inverse of the object-mapping matrix E using the amplitude preference-matrix A for weighing the object channels according to a desired preference (e.g., preference to the dominant direction of arrival). In some embodiments, the preferred amplitudes of the m object channels aₘ, are determined according to the principles of Equation 18 below. The coefficients of matrices E and D can be precomputed and stored in memory (e.g., of a playback or intermediate device) or computed on the fly for streaming audio according to the principles of Equation 17 discussed below.

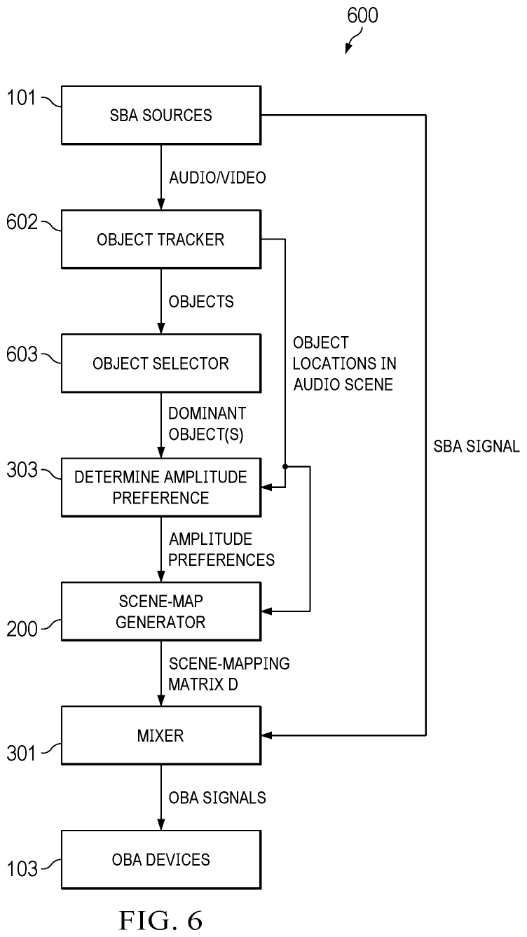

FIG. 2 shows a scene mapping matrix generator 200, according to one or more embodiments. Scene mapping matrix generator 200 includes determine object-mapping matrix process 201 and determine scene-mapping matrix process 202. M object locations 204, Vₘ, are used by object-mapping matrix process 201 to generate the object-mapping matrix, E, 205, according to the principles described in connection with Equation 8. The determine scene-mapping matrix process 202 combines amplitude preference coefficients 207, aₘ, with object-mapping matrix, E, 205 to form the scene-mapping matrix 206, D, according to the principles of Equation 15 or Equation 16. In an embodiment, the M object locations 204 can be provided in metadata of an SBA bitstream (e.g., MPEG-H bitstream), or provided by an external source, such as a video analyzer, as described in reference to FIG. 6.

### Deriving Amplitude Preference Coefficients

In an embodiment, analysis of the SBA signals can be employed to estimate the dominant DOA, (the unit-vector V_{dom}), of audio elements within the audio scene, along with a directional bias coefficient, 0≤b≤1, that indicates the fraction of the energy in the audio signal that is estimated to emanate from the dominant direction. For each object audio channel (m=1, 2, . . . , M), the amplitude preference coefficients, aₘ may be computed as a function of the object locations, Vₘ, the dominant direction. V_{dom} and the directional bias, b, as shown in Equation 17:

$${a}_{m} = f ( {V}_{m} , {V}_{dom} , b ) . \qquad ( 17 )$$

In an embodiment, the function ƒ( ) is chosen so that aₘ will be larger when Vₘ−V_{dom} is smaller, and when b is larger.

In an embodiment, the function ƒ( ) is determined according to the principles of Equation 18:

$$\begin{matrix}{a}_{m} = f ( {V}_{m} , {V}_{dom} , b ) \\ = \frac{1}{100} + {e}^{( 2 〈 {V}_{m} , {V}_{d o m} 〉 \sqrt{b} )}\end{matrix} , \qquad ( 18 )$$

where [symbol] Vₘ, V_{dom} [symbol] is the dot-product of the unit-vectors Vₘ and V_{dom}.

The function in Equation 18 will provide larger values of the amplitude preference, aₘ, for an object with incident direction Vₘ that lies closer to the dominant audio direction, V_{dom}, with the amplitude preference varying more, between different object channels, when the directional bias, b is larger.

FIG. 3 shows an arrangement 300 including the elements of scene mapping matrix generator 200 of FIG. 2, which produces the scene-mapping matrix 317, D, from M amplitude preference coefficients 315, aₘ, and M object locations 316, Vₘ. The arrangement 300 can be included in an encoder or decoder or generalized processor implemented in an audio playback device and/or intermediate processing device, or any other device, that processes or renders object-based signals (e.g., Dolby Atmos®).

The M-channel SBA signal 311 (e.g., HOA signal), S(t), can be received in a bitstream (e.g., MPEG-H bitstream). The M-channel SBA signal 311 is combined (e.g., multiplied) with scene-mapping matrix 317, D, by mixer 301 to produce the N-channel OBA signals 312, O(t), according to the principles of Equation 7.

In an embodiment, SBA signal 311 can be provided by, for example, a broadcaster at a “live” event, such as a sporting event or concert. The SBA signal can be generated from audio signals captured by one or more HOA microphones located at the event. For example, for a basketball game, HOA microphones (e.g., spot mics, ambience mics) can be placed at opposite ends of the basketball court and center court, as well as mounted to the ceiling. The broadcaster can use a mixing console with an HOA panner to mix the microphone signals together with commentary (e.g., in different languages), and output SBA signals. The HOA panner creates SBA signals based on audio inputs (e.g., audio objects and spot microphones), and the properties of the sound sources (e.g., position of sound source in 3D space and width).

The mixing engineer can also apply various spatial effects to the SBA signal (e.g., rotation of sound scene to align with a camera view, mirroring, warping, zooming to a specific direction). In some embodiments, the mixing console can also output OBA signals and CBA signals for added flexibility for different listening environments. For example, dialogues, commentaries in multiple languages, or audio descriptions can be sent as separate OBA signals, if needed. In some embodiments, the SBA signals can be reproduced through headphones via an SBA to binaural rendering module known in the art and paired to a head mounted display (HMD) to allow real time adaptation of a 3D sound field to the user's head rotations in, for example, virtual reality (VR) or augmented reality (AR) productions.

An advantage of using an SBA signal is that the SBA signal mitigates problems that may arise with OBA signals due to limited delivery bandwidth, complexity constraints of consumer devices and scene manipulation. SBA format is loudspeaker agnostic and thus allows the rendering of SBA content on arbitrary loudspeaker layouts. The SBA format also enables users to personalize and interact with the immersive audio content.

Referring again to FIG. 3, the SBA signal 311 is processed by analyze scene-based signals process 302 to determine the dominant direction 313, V_{dom}(t), and bias 310, b(t), corresponding to the characteristics of the SBA signal 311 over a time period around time t. Determine amplitude preferences process 303 combines the M object locations 316 (defined by object direction vectors Vₘ) with dominant direction vector 313 (V_{dom}(t)) and bias 310 (b(t)) output by analyze scene-based signal process 302 to form the M amplitude preference coefficients 315, aₘ, according to the principles of Equation 18, which are also the coefficients of amplitude preference matrix A used in Equation 16 to generate the scene-mapping matrix D. The object locations 316 and M amplitude preference coefficients 315 are input into scene mapping matrix generator 200, which outputs the scene-mapping matrix 317 that is multiplied with the SBA signal in mixer 301 to generate the OBA signals, as previously described in reference to FIG. 2. The OBA signals are then stored and/or transported (e.g., via MPEG-H bitstream) to various OBA devices for playback of an OBA representation or CBA representation of the original audio signal, or further processed before transporting to other downstream devices.

In some embodiments, the object locations 316 are part of streamed SBA metadata (e.g., MPEG-H bitstream) or provided by an external source, such as a video scene analyzer, as described in reference to FIG. 6. In some embodiments, object locations 316 can be static or dynamic. Some examples of dynamic locations include, but are not limited to: locations generated by video analysis tracking, such as a basketball or football, in a sports field, a referee, a coach and/or any region where the video analysis detects significant movement (e.g., a fight on hockey rink), or pre-set locations, such as the location of the backboards in a basketball court where the camera (and associated HOA microphone) are fixed in position/orientation, or any other position information (e.g., position information set manually by the content creator).

### Computing Dominant Direction and Bias Based on Covariance of SBA Signal

In some embodiments, the [M×M] covariance of a SBA input signal, over a time period around time t is formed as per the principles of Equation 19:

$$C ( t ) = {\int }_{τ = - ∞}^{∞} r ( τ - t ) [ \begin{matrix}{S}_{1} ( τ ) \overline{{S}_{1} ( τ )} & {S}_{1} ( τ ) \overline{{S}_{2} ( τ )} & … & {S}_{1} ( τ ) \overline{{S}_{M} ( τ )} \\ {S}_{2} ( τ ) \overline{{S}_{1} ( τ )} & {S}_{2} ( τ ) \overline{{S}_{2} ( τ )} & … & {S}_{2} ( τ ) \overline{{S}_{M} ( τ )} \\ ⋮ & ⋮ & ⋱ & ⋮ \\ {S}_{M} ( τ ) \overline{{S}_{1} ( τ )} & {S}_{M} ( τ ) \overline{{S}_{2} ( τ )} & … & {S}_{M} ( τ ) \overline{{S}_{M} ( τ )}\end{matrix} ] , \qquad ( l9 )$$

where the window function, r(τ), has a maximal value around τ=0, and hence the window function r(τ−t), has a maximal value around τ=t, thus ensuring that the covariance, C(t), represents the properties of the scene-based signal at the time around time t. The covariance C(t) may be pre-computed and stored in memory of a playback or intermediate processing device, included in bitstream metadata for the scene-based signal (e.g., MPEG-H bitstream metadata) or computed on the fly.

It will be appreciated that, when audio signals are represented in discrete-time samples, as is known in the art, the integration operation according to the principles of Equation 19 may be replaced with a discrete summation operation.

The bias b may be determined according to the principles of Equation 20:

$$b = \frac{1}{M - 1} ( M \frac{{‖ C ‖}_{F}^{2}}{tr {( C )}^{2}} - 1 ) , \qquad ( 20 )$$

where the operator

$${‖ C ‖}_{F}^{2}$$

is the square of the Frobenius norm of C (the sum of the squares of the magnitudes of the elements of C), and tr(C) is the trace of C (the sum of the diagonal entries).

In an embodiment, the dominant direction, V_{dom}, may be determined to be the unit vector that maximizes the value of

$${V}_{dom}^{*} \times {C}^{- 1} \times {V}_{d o m} .$$

In an embodiment, the SBA signals may be defined according to a first order Ambisonics panning function, P(x,y,x)=P₁(x,y,z), where P₁(x,y,z) is defined in Equation 21,

$${P}_{1} ( x , y , z ) = [ \begin{matrix}1 \\ y \\ z \\ x\end{matrix} ] , \qquad ( 21 )$$

and the dominant direction V_{dom} may be formed from three elements from the covariance matrix,

$${V}_{dom} = \frac{1}{\sqrt{{\vert {C}_{2 , 1} \vert}^{2} + {\vert {C}_{3 , 1} \vert}^{2} + {\vert {C}_{4.1} \vert}^{2}}} [ \begin{matrix}R e ( {C}_{4 , 1} ) \\ R e ( {C}_{2 , 1} ) \\ R e ( {C}_{3 , 1} )\end{matrix} ] , \qquad ( 22 )$$

where Re( ) indicates the real part of a coefficient (as may be required when the covariance matrix includes complex values), and the subscript C_{m,1} indicates the element at row m of column 1 of the matrix C.

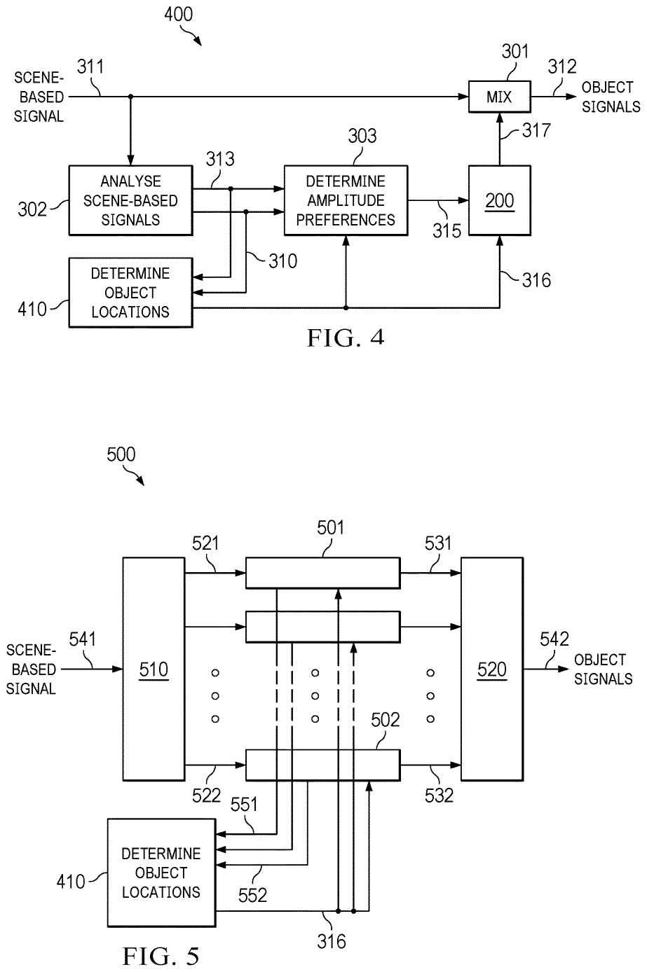

FIG. 4 shows an arrangement 400 that includes the elements of FIG. 3, with the addition of determine object locations process 410, adapted to take the dominant direction 313, V_{dom}(t), and bias 310, b(t), and to produce a set of object locations 316. As described in reference to FIG. 3, in some embodiments, the object locations 316 are part of streamed metadata or provided by an external source, such as a video scene analyzer, as described in reference to FIG. 6. The embodiment in FIG. 4 determines the object locations 316 based on the dominant direction 313 and bias 310 and provides the determined object locations 316 to determine amplitude preferences process 303. The processes shown in FIG. 4 can be applied to SBA signals that are streamed and/or retrieved from a storage medium. These processes can be included in an encoder or decoder of any source, receiver, or intermediate device, and for any application that would benefit from converting an SBA representation to an OBA representation.

Referring to block 410 in FIG. 4, object locations 316, {Vₙ: n=1 . . . N} can include a number K fixed object locations, and L dynamic object locations, where L+K=N. In a preferred embodiment, K≥M, and the K fixed object locations 316 are chosen so that the object locations, {Vₙ: n=L+1 . . . N} are approximately evenly spread around the listener.

In a further embodiment, L=1, and the dynamic object V₁ is located according to the dominant direction, V_{dom}, of the scene-based signal, S(t). Hence, object locations 316 may be determined according to the principals discussed in connection to Equation 23:

$${V}_{m} = \{ \begin{matrix}{V}_{d o m} & when m = 1 \\ {V}_{f i xed , m - 1} & otherwise\end{matrix} . \qquad ( 23 )$$

It is an aspect of the present invention to convert an SBA signal to an OBA signal, according to the principles discussed in connection with Equation 9, where the scene-mapping matrix, D, is adapted to vary over time according to characteristics of the SBA signal. It is known in the art to implement the conversion of an SBA signal to a less discrete OBA signal, O′(t), according to:

$${O}^{′} ( t ) = {D}_{fix} \times S ( t ) , \qquad ( 24 )$$

wherein the scene-mapping matrix, D_{fix}, is fixed. D_{fix} is referred to as a passive-decode matrix, and the resulting object-based signal, O′(t), as a passively decoded OBA signal. One example of a fixed decoding matrix, known in the art, is formed from the pseudo-inverse of the object-mapping matrix, E, according to:

$${D}_{fix} = {E}^{+} . \qquad ( 25 )$$

In some embodiments, the amplitude preference coefficients, aₙ, for each channel object audio channel (n=1 . . . N), can be determined from the amplitude or power of the corresponding channel of a passively decoded object-based signal.

In a further preferred embodiment, the amplitude preference coefficient, aₙ, at time t, is determined by:

$${a}_{n} = {\int }_{τ = - ∞}^{∞} r ( τ - t ) {\vert {O}_{n}^{′} ( τ ) \vert}^{2} , \qquad ( 26 )$$

where O′ₙ(t) refers to the n^{th} channel of the passively decoded OBA signal, and the window function, r(τ), has a maximal value around τ=0, and hence the window function r(τ−t), has a maximal value around τ=t, thus ensuring that amplitude preference coefficient, aₙ, is derived from the power of the n^{th} channel of the passively decoded OBA signal at the time around time t.

In a further embodiment, the covariance matrix determined according to the principles discussed in connection with Equation 19 may be used, in combination with the principles discussed in connection with Equation 24, to determine aₙ according to:

$${a}_{n} = {\{ {D}_{fix} \times C ( t ) \times {D}_{f i x}^{*} \}}_{n , n} , \qquad ( 27 )$$

where {^{□}}_{n,n} refers to the n^{th} element on the diagonal of the matrix C. Hence, the set of amplitude preferences (aₙ: n=1 . . . N) are formed from the diagonal of the matrix C:

$${D}_{fix} \times C ( t ) \times {D}_{fix}^{*} .$$

In a further embodiment, the method of Equation 27 may be re-written as:

$${a}_{n} = {\sum }_{m 1 = 1}^{N} {\sum }_{m 2 = 1}^{N} {h}_{n , m 1 , m 2} {\{ C ( t ) \}}_{m 1 , m 2} , \qquad ( 28 )$$

where h_{n,m1,m2} may be defined according to:

$${h}_{n , m 1 , m 2} = {\{ {D}_{fix} \}}_{n , m 1} {\{ {D}_{fix} \}}_{n , m 2} , \qquad ( 29 )$$

or, in the case where the matrix D_{fix} contains complex elements:

$${h}_{n , m 1 , m 2} = {\{ {D}_{fix} \}}_{n , m 1} \overline{{\{ {D}_{fix} \}}_{n , m 2}} . \qquad ( 30 )$$

In another embodiment, the amplitude preference coefficients, aₙ, can be determined according to the principles discussed in connection with Equation 28, wherein the coefficients, h_{n,m1,m2}, are determined by alternative methods, as discussed below.

It will be appreciated that, where Equation 5 shows the panning function, P(V), that defines the panning rule for the SBA signal format, a panning function, P′(V), can define the panning rule for the OBA signal format.

$${P}^{′} ( V ) = [ \begin{matrix}{g}_{1}^{′} ( V ) \\ {g}_{2}^{′} ( V ) \\ ⋮ \\ {g}_{N}^{′} ( V )\end{matrix} ] , \qquad ( 31 )$$

where the panning gains (g′ⱼ: j=1 . . . J) defined by the panning function P′(V) may be used to determine the target OBA signals:

In an embodiment, the object-based panning function P′(V) is defined in accordance with the method of Vector-Based Amplitude Panning (VBAP), as is known in the art.

For any original audio signals with an associated direction of arrival, U′, the contribution of the original audio signal to the SBA signals will result in a covariance that is proportional to:

$$\begin{matrix}{C}_{{U}^{′}} = P ( {U}^{′} ) \times {P ( {U}^{′} )}^{*} \\ = [ \begin{matrix}{g}_{1} ( {U}^{′} ) \overline{{g}_{1} ( {U}^{′} )} & {g}_{1} ( {U}^{′} ) \overline{{g}_{2} ( {U}^{′} )} & … & {g}_{1} ( {U}^{′} ) \overline{{g}_{M} ( {U}^{′} )} \\ {g}_{2} ( {U}^{′} ) \overline{{g}_{1} ( {U}^{′} )} & {g}_{2} ( {U}^{′} ) \overline{{g}_{2} ( {U}^{′} )} & … & {g}_{2} ( {U}^{′} ) \overline{{g}_{M} ( {U}^{′} )} \\ ⋮ & ⋮ & ⋱ & ⋮ \\ {g}_{M} ( {U}^{′} ) \overline{{g}_{1} ( {U}^{′} )} & {g}_{M} ( {U}^{′} ) \overline{{g}_{2} ( {U}^{′} )} & … & {g}_{M} ( {U}^{′} ) \overline{{g}_{M} ( {U}^{′} )}\end{matrix} ] ,\end{matrix} \qquad ( 32 )$$

and it will also be appreciated that, for the original audio signals with an associated direction of arrival, U′, the n^{th} channel of the OBA signal will have an expected amplitude of g′ₙ(U′), according to the object-based panning function of Equation 31.

In an embodiment, gain coefficients h_{n,m1,m2} are determined so that for each n=1 . . . N. and for a range of unit-vectors, U′:

$${g}_{n}^{′} ( {U}^{′} ) \approx {\sum }_{m 1 = 1} {\sum }_{m 2 = 1} {{h}_{n , m 1 , m 2} ( {C}_{{U}^{′}} )}_{m 1 , m 2} , \qquad ( 33 )$$

or, more specifically, so that the error:

$$e r {r}_{n} ( {U}^{′} ) = {( {g}_{n}^{′} ( {U}^{′} ) - {\sum }_{m 1 = 1} {\sum }_{m 2 = 1} {{h}_{n , m 1 , m 2} ( {C}_{{U}^{′}} )}_{m 1 , m 2} )}^{2} \qquad ( 34 )$$

is minimized when averaged over a range of directions of arrival, U′. In a further embodiment, h_{n,m1,m2} is chosen so as to minimise:

$$\int {\int }_{{U}^{′} ∈ S 2} e {rr}_{n} ( {U}^{′} ) {dU}^{′} , \qquad ( 35 )$$

where the set S2 refers to the (2-dimensional) set of unit-vectors on the surface of the unit-sphere.

In an embodiment, the scale factors h_{n,m1,m2} (where n=1 . . . N, m1=1 . . . M and m2=1 . . . M) are defined so that the amplitude preference coefficients, aₙ (where n=1 . . . N), defined according to the principles of Equation 28, resemble the panning gains according to the g′(U′) when the covariance C is associated with a audio scene with a dominant sound at direction of arrival U′.

In another embodiment, the scale factors h_{n,m1,m2} (where n=1 . . . N, m1=1 . . . M and m2=1 . . . M) are defined so that each of the amplitude preference coefficients, aₙ (where n=1 . . . N), defined according to the principles of Equation 28, resembles the expected amplitude of respective OBA channel Oₙ when the covariance C is associated with a audio scene with a dominant sound at direction of arrival V.

### Subband Scene-Based Signal Embodiment.

In an alternative embodiment, a scene-based signal 311 may be split into 2 or more subbands, according to frequency selective filtering processes. For each subband, the respective SBA subband signal may be converted to an OBA subband signal according to the methods described above (e.g., as per arrangement 300 in FIG. 3).

FIG. 5 shows an example arrangement 500 wherein SBA signal 541 is processed by a filter-bank analysis process 510 to produce a number of SBA subband signals, e.g., 521a . . . 521n. For each subband SBA signal, e.g., 521a . . . 521n, a corresponding processing block, e.g., 501a . . . 501n, processes the subband scene-based signal. e.g., 521a . . . 521n, to form a respective subband object-based signal, e.g., 531a . . . 531n. Subband object-based signals, e.g., 531a . . . 531n, are combined by subband synthesis process 520, to form object-based signal 542.

Each processing block 501a . . . 501n of FIG. 5 may be implemented according to a method such as that shown in the arrangement 300 of FIG. 3 wherein the object locations 316 of FIG. 3 are determined by a determine object location process 410 (in FIG. 5). According to the embodiment of arrangement 500 in FIG. 5, each processing block, e.g., 501a . . . 501n, determines subband status data (551a . . . 551n respectively) that can be used by determine object location process 410, to assist in the determining of object locations 316.

Subband status data, 551a . . . 551n, may include data indicative of the loudness of the scene-based signal in the respective subband. Subband status data. 551a . . . 551n, may also include the dominant-direction 313, V_{dom}, and bias 310 data in the respective subband, as shown in FIG. 3.

The determine object location, process 410 may determine the location of one more dynamic object(s) according to the set of dominant directions determined (by processing blocks, e.g., 501,512) for each subband. When only one (L=1) dynamic object is provided by determine object location process 410, the dynamic object location may be determined as the mean of the dominant directions determined for all subbands. In an embodiment, the dynamic object location may be determined as the weighted mean of the dominant directions determined for all sub-bands, according to a set of band weights. Band weights may vary so that, for each sub-band, the band-weight is larger when the loudness and/or bias of the said band is larger.

When two or more dynamic objects are determined by determine object location process 410, the location of the dynamic objects may be formed according to various methods known in the art. In an embodiment, a k-means clustering algorithm is used to determine the two or more centroids from the dominant directions determined for all subbands. In another embodiment, a weighted k-means clustering algorithm can be applied, wherein, for each subband, the band weight is larger when the loudness and/or bias of the said band is larger.

Combining Visual Object Tracking with Ambisonics Object Extractions

FIG. 6 is a block diagram of a system 600 for detecting dominant spatial objects to generate amplitude preference coefficients for scene-mapping matrix D (317 in FIGS. 4 and 5) that places the detected dominant spatial audio objects in a fewer number of output object channels in an OBA format, thus providing a more discrete OBA rendering of the SBA input signal, according one or more embodiments.

System 600 includes SBA sources 101, object tracker 602, object selector 603, determined amplitude preference process 303, scene-mapping generator 200 (see FIG. 2), mixer 301, and OBA devices 103. SBA sources 101 can be, for example, a broadcaster at a sporting event. Object tracker 602 can be, e.g., a video analyzer. Object selector 603 can be a process for selecting dominant object or other objects of interest from a plurality of objects (e.g., based on transients or other information). Determined amplitude preference process 303, scene-mapping generator 200, and mixer 301 operate as previously described in reference to FIGS. 2-3. OBA devices can be any downstream device that renders OBA signals for playback or further processing, including but not limited to mobile devices, home entertainment devices, automotive infotainment devices, headphones, intermediate process devices, etc.

In this example embodiment, the SBA sources 101 provide video streams and SBA audio streams (e.g., using MPEG-H transport). The video stream is input into object tracker 602 which detects objects and their corresponding locations across a sequence of video frames (e.g., using k-means). Object selector 603 selects one or more dominant objects or objects of interests to be mapped to OBA signals (e.g., based on transient analysis). The object locations are provided by the object tracker 602 to the determined amplitude preference process 303, which determines amplitude preference coefficients for the scene-mapping matrix D, as previously described in reference to FIGS. 1-4. The amplitude preference coefficients and object locations are input into scene-mapping generator 200, which generates a scene-mapping matrix 206/317 (D matrix), as described in reference to FIGS. 1-4. The scene-mapping matrix 206/317 is input to mixer 301, which uses the scene-mapping matrix D to convert the SBA signal into OBA signals, where the OBA channels are weighted in accordance with the amplitude preference coefficients, such that dominant spatial audio objects are placed in a fewer number of output OBA channels, to provide a more discrete OBA rendering of the SBA input signal.

When dynamic objects are generated the conversion process described above needs to react quickly to ensure that any new transient sonic element is detected, so that a dynamic object can be moved to the correct position prior to the transient event. In some embodiments, this can be done by ensuring that dynamic objects only move smoothly at a fairly slow speed, so the loudness/timbre changes are not so erratic. Even if one or more of the dynamic objects are in the wrong place in the audio object scene, that will not matter because there is no sound being generated in the neighborhood of those dynamic objects.

In some embodiments, object tracker 602 analyzes the video signal to identify dominant a sonically interesting object in the scene (e.g., the basketball in the previous example). There is a good likelihood that the dominant object location can be ‘seen’ to be moving in a nice continuous fashion based on the video analysis. This object location could then be used by the object separator 602 to produce an object-based scene (e.g., Atmos audio scene with Atmos objects placed exactly where the video analysis determined it should be). In some embodiments, the video analysis suggests a neighborhood and subsequent audio analysis moves an object (slowly) within that neighborhood.

In some embodiments, there can be sets of static objects that can be selected based on one or more trigger conditions, which can come from video and/or audio analysis, or some other input source. In this embodiment, sets of static objects can change dynamically. For example, in a basketball game there can be two sets of static objects: one set at each end of the court. The end of the court where the play is currently active can have a corresponding first set of static objects active, which dynamically switches to a second set of static objects at the opposite end of the court when the ball moves to the opposite end of the court as can be determined by video analysis. In some embodiments, the locations of the static objects in a particular set can be utilized to determine amplitude preferences 303 to generate amplitude preferences 315 that ensure that the particular set of objects are included in a fewer number of output OBA channels, to provide a more discrete OBA rendering of the SBA input signal.

In some embodiments, a video analyzer processes sequential video frames of an audio scene and outputs the movement of objects between the frames. The processing can include object tracking, filtering, and data association. Some examples of object tracking include but are not limited to kernel-based tracking (e.g., mean-shift tracking), iterative object localization based on the maximization of a similarity measure (e.g., a Bhattacharyya coefficient), or contour tracking that iteratively evolves an initial object contour by minimizing the contour energy using gradient descent. Filtering and data association can include incorporating prior information about the scene or object, dealing with object dynamics, and evaluation of different hypotheses, Some examples of filters include but are not limited to a Kalman filter or particular filter.

In some embodiments, the tracked objects are processed to determine dominant objects based on audio associated with the tracked objects (e.g., transient analysis). The dominant direction vector and bias can be determined for one or more dominant objects, which can be used to determine an amplitude-preference coefficient 314 for the scene-mapping matrix 206/317, which is to be applied to an SBA signal 311, as described above in reference to FIGS. 1-4.

### Example Processes

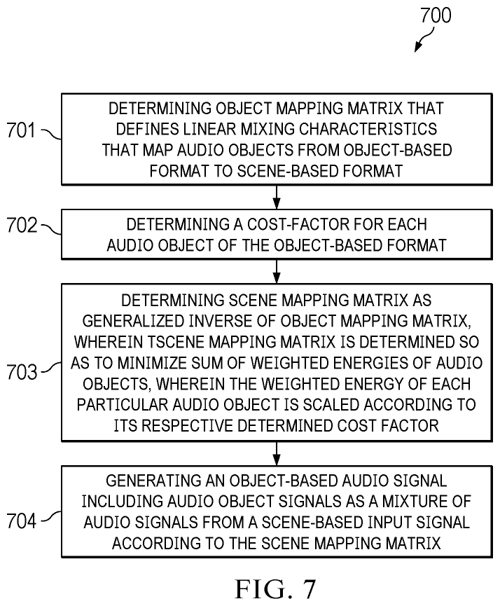

FIG. 7 is a flow diagram of an example process 700 for converting scene-based audio to object-based representation(s), according to one or more embodiments. Process 700 can be implemented using, e.g., the electronic device architecture 800 described in reference to FIG. 8.

In some embodiments, a method comprises: determining an object mapping matrix that defines linear mixing characteristics that map audio objects from an object-based format to a scene-based format (701); determining a cost-factor for each audio object of the object-based format (702); determining a scene mapping matrix as a generalized inverse of the object mapping matrix (703), wherein the scene mapping matrix is determined so as to minimize a sum of weighted energies of the audio objects, wherein the weighted energy of each particular audio object is scaled according to its respective determined cost factor; and generating an object-based audio signal including audio object signals as a mixture of audio signals from a scene-based input signal according to the scene mapping matrix (704). Each of these steps was previously described above.

### Example Computing Apparatus

FIG. 8 shows a block diagram of an example computing apparatus 800 suitable for implementing example embodiments of the present disclosure. Apparatus 800 includes but is not limited to servers and client devices, as previously described in reference to FIGS. 1-7.

As shown, the apparatus 800 includes central processing unit (CPU) 801 which is capable of performing various processes in accordance with a program stored in, for example, read only memory (ROM) 802 or a program loaded from, for example, storage unit 808 to random access memory (RAM) 803. In RAM 803, the data required when CPU 801 performs the various processes is also stored, as required. CPU 801, ROM 802, RAM 803 are connected to one another via bus 804. Input/output (I/O) interface 805 is also connected to bus 804.

The following components are connected to I/O interface 805: input unit 806, that may include a keyboard, a mouse, or the like; output unit 807 that may include a display such as a liquid crystal display (LCD) and one or more speakers: storage unit 808 including a hard disk, or another suitable storage device; and communication unit 809 including a network interface card such as a network card (e.g., wired or wireless).

In some implementations, input unit 806 includes one or more microphones in different positions (depending on the host device) enabling capture of audio signals in various formats (e.g., mono, stereo, spatial, immersive, and other suitable formats).

In some implementations, output unit 807 include systems with various number of speakers. Output unit 807 (depending on the capabilities of the host device) can render audio signals in various formats (e.g., mono, stereo, immersive, binaural, and other suitable formats).

In some embodiments, communication unit 809 is configured to communicate with other devices (e.g., via a network). Drive 810 is also connected to I/O interface 805, as required. Removable medium 811, such as a magnetic disk, aₙ optical disk, a magneto-optical disk, a flash drive, or another suitable removable medium is mounted on drive 810, so that a computer program read therefrom is installed into storage unit 808, as required. A person skilled in the art would understand that although computing apparatus 800 is described as including the above-described components, in real applications, it is possible to add, remove, and/or replace some of these components and all these modifications or alteration all fall within the scope of the present disclosure.

In accordance with example embodiments of the present disclosure, the processes described above may be implemented as computer software programs or on a computer-readable storage medium. For example, embodiments of the present disclosure include a computer program product including a computer program tangibly embodied on a machine-readable medium, the computer program including program code for performing methods. In such embodiments, the computer program may be downloaded and mounted from the network via the communication unit 809, and/or installed from the removable medium 811, as shown in FIG. 8.

Generally, various example embodiments of the present disclosure may be implemented in hardware or special purpose circuits (e.g., control circuitry), software, logic, or any combination thereof. For example, the units discussed above can be executed by control circuitry (e.g., CPU 801 in combination with other components of FIG. 8), thus, the control circuitry may be performing the actions described in this disclosure. Some aspects may be implemented in hardware, while other aspects may be implemented in firmware or software which may be executed by a controller, microprocessor, or other computing device (e.g., control circuitry). While various aspects of the example embodiments of the present disclosure are illustrated and described as block diagrams, flowcharts, or using some other pictorial representation, it will be appreciated that the blocks, apparatus, systems, techniques, or methods described herein may be implemented in, as non-limiting examples, hardware, software, firmware, special purpose circuits or logic, general purpose hardware or controller or other computing devices, or some combination thereof.

Additionally, various blocks shown in the flowcharts may be viewed as method steps, and/or as operations that result from operation of computer program code, and/or as a plurality of coupled logic circuit elements constructed to carry out the associated function(s). For example, embodiments of the present disclosure include a computer program product including a computer program tangibly embodied on a machine-readable medium, the computer program containing program codes configured to carry out the methods as described above.

In the context of the disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may be non-transitory and may include but not limited to an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Computer program code for carrying out methods of the present disclosure may be written in any combination of one or more programming languages. These computer program codes may be provided to a processor of a general-purpose computer, special purpose computer, or other programmable data processing apparatus that has control circuitry, such that the program codes, when executed by the processor of the computer or other programmable data processing apparatus, cause the functions/operations specified in the flowcharts and/or block diagrams to be implemented. The program code may execute entirely on a computer, partly on the computer, as a stand-alone software package, partly on the computer and partly on a remote computer or entirely on the remote computer or server or distributed over one or more remote computers and/or servers.

While this document contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can, in some cases, be excised from the combination, and the claimed combination may be directed to a sub combination or variation of a sub combination. Logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

1. A method comprising;
determining, with at least one processor, an object mapping matrix that defines linear mixing characteristics that map audio objects from an object-based format to a scene-based format;
determining, with the at least one processor, a cost-factor for each audio object of the object-based format;
determining, with the at least one processor, a scene mapping matrix as a generalized inverse of the object mapping matrix, wherein the scene mapping matrix is determined so as to minimize a sum of weighted energies of the audio objects, wherein the weighted energy of each particular audio object is scaled according to its respective determined cost factor; and
generating, with the at least one processor, an object-based audio signal including audio object signals as a mixture of audio signals from a scene-based input signal according to the scene mapping matrix.

2. The method of claim 1, wherein the scene-based input signal is an M-channel multi-channel audio signal, each cost factor is a function of an amplitude preference for its corresponding audio object, and the amplitude preference of each audio object is determined from a weighted sum of the elements of the matrix, C, where C is an M×M covariance of the M-channel scene-based input signal, and where the weights are determined so as to form amplitude preference values that approximate an object-based panning function.

3. The method of claim 1, wherein each of the audio objects is associated with an object location, the scene-based input signal is associated with a dominant direction, and each of the cost factors is defined to be lower for audio objects with associated object locations that are closer to the dominant direction.

4. The method of claim 3, further comprising:
estimating, from the scene-based input signal, the dominant direction and a directional bias coefficient that indicates a fraction of the scene-based input signal energy that emanates from the dominant direction.

5. The method of claim 4, wherein each cost factor is a function of an amplitude preference for its corresponding audio object, and the amplitude preference is a function of an incident direction of the audio object, the dominant direction, and the direction bias coefficient.

6. The method of claim 5, wherein the function provides larger values of the amplitude preference when the incident direction lies closer to the dominant direction.

7. The method of claim 6, wherein the scene-based input signal is an M-channel multi-channel audio signal and the dominant direction, Vdom, is a unit vector that maximizes the value of
$${V}_{d o m}^{*} \times {C}^{- 1} {V}_{d o m} ,$$
where C is an M×M covariance of the M-channel scene-based input signal, and where the “*” operator indicates a transpose.

8. The method of claim 7, where the dominant direction is formed from elements of the covariance matrix C.

9. The method of claim 1, wherein the audio object is a dynamic audio object having a location that is determined through video scene analysis.

10. The method of claim 1, wherein the scene-based input signal is defined according to a first order Ambisonics panning function.

11. The method of claim 1, wherein the scene-based input signal is split into two or more subband scene-based signals according to a frequency selective filtering process, where for each subband the respective scene-based subband signal is converted to a separate object-based subband signal.

12. A non-transitory computer-readable storage medium storing instructions which, when executed by a computing apparatus, cause the computing apparatus to perform the method of claim 1.

13. A computing apparatus, comprising:
at least one processor configured to:
determine an object mapping matrix that defines linear mixing characteristics that map audio objects from an object-based format to a scene-based format;
determining, with the at least one processor, a cost-factor for each audio object of the object-based format;
determine a scene mapping matrix as a generalized inverse of the object mapping matrix, wherein the scene mapping matrix is determined so as to minimize a sum of weighted energies of the audio objects, wherein the weighted energy of each particular audio object is scaled according to its respective determine cost factor; and
generate an object-based audio signal including audio object signals as a mixture of audio signals from a scene-based input signal according to the scene mapping matrix.
